(19) United States
(12) Patent Application Publication
(10) Pub. No.: US 2026/0038280 A1
(43) Pub. Date: Feb. 5, 2026

(54) TRANSMISSION DATA GENERATION APPARATUS, METHOD, AND PROGRAM PRODUCT

(71) Applicants: DENSO CORPORATION, Kariya-City (JP); TOYOTA JIDOSHA KABUSHIKI KAISHA, Toyota-shi (JP); J-QuAD DYNAMICS Inc., Tokyo (JP)

(72) Inventors: Minoru YOKOTA, Tokyo (JP); Genki KITAHARA, Tokyo (JP); Satoshi HORIHATA, Kariya-City (JP); Hiroki FUKATSU, Tokyo (JP)

(21) Appl. No.: 19/285,688

(22) Filed: Jul. 30, 2025

(30) Foreign Application Priority Data
Aug. 5, 2024 (JP) 2024-128686

(51) Int. Cl. G06V 20/58; G06T 7/73

(52) U.S. Cl. CPC G06V 20/584; G06T 7/73; G06T 2207/10028; G06T 2207/30252

(57) ABSTRACT

In a transmission data packet generation apparatus, a transmission-target data determiner determines, when each of sequential feature data items includes a static data item so that sequential static data items as the sequential feature data items are defined, whether a first determination condition for identifying one of the sequential static data items as one or more transmission targets is satisfied. The transmission-target data determiner determines, when each of the sequential feature data items includes a dynamic data item so that sequential dynamic data items as the sequential feature data items are defined, whether a second determination condition for identifying one of the sequential dynamic data items as the one or more transmission targets is satisfied. The first determination condition and the second determination condition are independent from each other.

### REFERENCE TO RELATED APPLICATIONS

This application is based on and claims the benefit of priority from Japanese Patent Application No. 2024-128686 filed on Aug. 5, 2024, the disclosure of which is incorporated in its entirety herein by reference.

### TECHNICAL FIELD

The present disclosure relates to transmission data generation apparatuses, transmission data generation methods, and program products.

### BACKGROUND

Known technologies transmit, to a server, data indicative of features existing around a vehicle acquired by sensors, such as cameras installed in the vehicle.

Japanese Patent Application Publication No. 2023-125484 discloses such a data transmission system. The system is configured such that a device installed in a vehicle, which is comprised of a drive recorder, uploads, to a management system, vehicle-related information on the vehicle. The vehicle-related information includes, for example, captured images and positional information on the vehicle, the speed information on the vehicle, and steering information on the vehicle.

### SUMMARY

Feature data indicative of a feature existing around a vehicle includes, for example, static data, such as data indicative of the size of a traffic light, that does not change over time. Additionally, the feature data includes, for example, dynamic data, such as illumination information on a traffic light, that is changeable over time.

Various types of feature data, such as static data and dynamic data, may have different levels of reliability depending on their types.

Unfortunately, the data transmission system disclosed in the patent publication is configured to determine, as a transmission target to a receiving side, one of the various types of data in accordance with a predetermined uniform standard regardless of the types of data. This therefore may result in one of the various types of data, which has a relatively low level of reliability, being determined as the transmission target to the receiving side.

For this reason, users seek to achieve a technology, which is capable of limiting transmission of data having a relatively low level of reliability to a receiving side.

An exemplary aspect of the present disclosure provides a transmission data generation apparatus for a vehicle. The transmission data generation apparatus includes a data recognition unit configured to recognize, based on measurements from at least one sensor mounted to the vehicle, a target feature, and generate, based on the target feature, sequential feature data items, each of which represents the target feature. Each of the sequential feature data items includes at least one of a dynamic data item that is changeable over time and a static data item that does not change over time.

The transmission data generation apparatus includes a transmission-target data determiner.

The transmission-target data determiner is configured to determine, when each of the sequential feature data items includes the static data item so that sequential static data items as the sequential feature data items are defined, whether a first determination condition for identifying one of the sequential static data items as one or more transmission targets is satisfied.

The transmission-target data determiner is additionally configured to determine, when each of the sequential feature data items includes the dynamic data item so that sequential dynamic data items as the sequential feature data items are defined, whether a second determination condition for identifying one of the sequential dynamic data items as the one or more transmission targets is satisfied. The first determination condition and the second determination condition are independent from each other.

The transmission data generation apparatus includes a transmission data generator configured to perform at least one of
(I) A first task of generating, in response to determination that the first determination condition is satisfied, transmission-target data based on the one of the sequential static data items, and
(II) A second task of generating, in response to determination that the second determination condition is satisfied, the transmission-target data based on the one of the sequential dynamic data items.

The transmission-target data determiner of the transmission data generation apparatus according to the exemplary aspect is configured to determine, when each of the sequential feature data items includes the static data item so that sequential static data items as the sequential feature data items are defined, whether a first determination condition for identifying one of the sequential static data items as one or more transmission targets is satisfied.

The transmission-target data determiner is additionally configured to determine, when each of the sequential feature data items includes the dynamic data item so that sequential dynamic data items as the sequential feature data items are defined, whether a second determination condition for identifying one of the sequential dynamic data items as the one or more transmission targets is satisfied. The first determination condition and the second determination condition are independent from each other.

This makes it possible to
(I) Determine, as the first determination condition, a condition that enables selection of a static data item with a high level of reliability from the sequential static data items, and
(II) Determine, as the second determination condition, a condition that enables selection of a dynamic data item with a high level of reliability from the sequential dynamic data items

This therefore makes it possible to generate the transmission-target data based on the selected static data item and/or the selected dynamic data item, each of which has a higher level of reliability, thus limiting transmission of one or more feature data items which have a relatively low reliability.

### BRIEF DESCRIPTION OF THE DRAWINGS

The above object, other objects, characteristics, and advantageous benefits of the present disclosure will become apparent from the following description with reference to the accompanying drawings in which:

FIG. 1 is a block diagram illustrating a schematic configuration of an information collecting system that includes in-vehicle devices to each of which a transmission data generation apparatus according to an exemplary embodiment of the present disclosure has been applied;

FIG. 2 is a front view schematically illustrating an example of the configuration of a traffic light used as a feature;

FIG. 3A is a flowchart schematically illustrating a feature-data generation routine according to the exemplary embodiment;

FIG. 3B is a flowchart schematically illustrating a transmission-data generation routine according to the exemplary embodiment;

FIG. 4 is a flowchart schematically illustrating a transmission-target data determination subroutine in step S20 of FIG. 3B;

FIG. 5 is a flowchart schematically illustrating a subroutine in step S110 of FIG. 4;

FIG. 6 is an image sequence diagram illustrating the sequence of images captured at sequential times;

FIG. 7 is a graph schematically illustrating (i) a temporal variation of an estimation-method reliability of sequential static data items corresponding to a determination target feature, and (ii) a temporal variation of a housing-recognition reliability of the sequential static data items corresponding to the determination target feature; and

FIG. 8 is a flowchart schematically illustrating a subroutine in step S120 of FIG. 4.

### DETAILED DESCRIPTION OF EMBODIMENT

The following describes an exemplary embodiment and its modifications of the present disclosure with reference to accompanying drawings.

### EXEMPLARY EMBODIMENT

### System Configuration

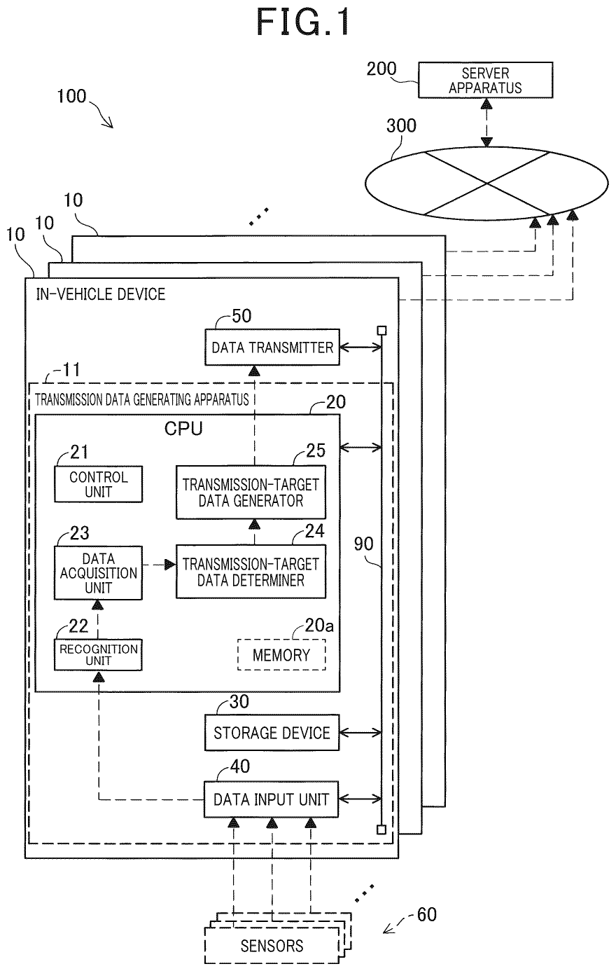

An information collecting system 100 illustrated in FIG. 1 includes (i) a plurality of in-vehicle devices 10 installed in a plurality of respective unillustrated vehicles, and (ii) a server system 200 that is communicably connected to the in-vehicle devices 10 through a network 300.

In the information collecting system 100, each in-vehicle device 10 is configured to transmit feature data acquired thereby to the server system 200 through the network 300, and the server system 200 is configured to collect the feature data uploaded from each in-vehicle device 10. Transmitting data from each in-vehicular device 10 to the server system 200 will also be referred to as uploading data therefrom.

The feature data for a vehicle means data indicative of at least one feature, i.e., at least one geographic feature, which can be recognized from measurements from sensors 60 mounted to the vehicle. The server system 200 is configured to store the feature data collected from each of the in-vehicle devices 10, and generate, based on the stored feature data items, three-dimensional map data. For example, the three-dimensional map data includes
(I) Three-dimensional road position information items, each of which represents the longitudinal and latitudinal coordinates of a corresponding one of sections of a corresponding one of roads
(II) Three-dimensional natural/artificial feature position information items, each of which represents the three-dimensional longitudinal and latitudinal coordinates of a corresponding one of natural/artificial features, such as buildings or guardrails, on or around the roads
(III) Road-related information items, each of which is related to the corresponding one of the roads
(IV) Timestamp information items, i.e., Year/month/day/time information items, each of which represents the year, month, day, and time that the corresponding one of the information items (I), (II), and (III) was updated

The server system 200 is configured to transmit, i.e., download, the generated three-dimensional map data to each in-vehicle device 10 of the corresponding vehicle. Each in-vehicle device 10 can be configured to perform driving-assistance control operations of the corresponding vehicle using the downloaded three-dimensional map data. Detailed information on the feature data will be described later.

The server system 200 is comprised of, for example, one or more computers installed in a data center. The network 300 includes, for example, a communication network, such as a Wide Area Network (WAN) provided by, for example, a telecommunications carrier, a wireless local-area network (LAN), and/or a wired LAN.

Each in-vehicle device 10 includes a transmission data generating apparatus 11 and a data transmitter 50.

The transmission data generating apparatus 11 is configured to generate data packets, each of which includes feature data acquired by the corresponding in-vehicle device 10.

The data transmitter 50 of each in-vehicle device 10 is configured to transmit, i.e., update, the data packets to the server system 200 through the network 300. The data transmitter 50 of each in-vehicle device 10 is configured to perform mobile communication, such as 4G (Fourth Generation Communication) or 5G (Fifth Generation Communication) to accordingly update the feature data from the current position of the corresponding vehicle to the server system 200.

The transmission data generating apparatus 11 of each in-vehicle device 10 is configured to receive measurements from the sensors 60 mounted to the corresponding vehicle, and identify or recognize, based on the measurements, feature data for the corresponding vehicle. Then, the transmission data generating apparatus 11 of each in-vehicle device 10 is configured to generate one or more data packets that include the feature data, and transfer the data packets to the data transmitter 50.

The sensors 60 of each vehicle are each configured to measure information related to the surrounding environment around the corresponding vehicle. The sensors 60 include, for example, various types of sensors, such as one or more imaging cameras including a front camera, one or more millimeter-wave radars, one or more sonars, one or more Light Detection and Ranging (Lidar) sensors, and a position detection sensor. The position detection sensor includes, for example, a global navigation satellite system (GNSS) receiver, such as a global positioning system (GPS) receiver, which is configured to receive GPS signals, which are sent from GPS satellites, and identify, based on the received GPS signals, the current position of the corresponding vehicle.

The transmission data generating apparatus 11 of each in-vehicle device 10 includes a CPU 20, a storage device 30, and a data input unit 40. The data transmitter 50, the CPU 20, the storage device 30, and the data input unit 40 are configured to communicate data with one another through an internal bus 90.

The storage device 30 is comprised of, for example, one or more read-only memories (ROMs) and one or more random access memories (RAMs). The storage device 30 stores computer programs, i.e., computer-program instructions, that cause the CPU 20 to serve as a controller of the transmission data generating apparatus 11. The CPU 20 has, for example, an internal memory 20a, and is configured to execute the computer-program instructions to serve as a control unit 21, a recognition unit 22, a data acquisition unit 23, a transmission-target data determiner 24, and a transmission data generator 25.

The control unit 21 is configured to control the overall operations of the transmission data generating apparatus 11.

The recognition unit 22 is configured to successively recognize features existing around the corresponding vehicle based on the measurements from the sensors 60 successively inputted thereto through the data input unit 40.

The term “features” existing around a vehicle refers to various types of features, i.e., geographic features, existing around the vehicle, which may be used for generating a three-dimensional map or for assisting the driving of the vehicle.

The features existing around a vehicle include, for example, signboards, traffic lights, landmarks, and traffic signs located around the road on which the vehicle is traveling, which will be referred to as a “travel road”. The features existing around a vehicle also include road markers drawn on the surface of the travel road, such as stop lines, pedestrian crossings, arrow markings, lane markings, and indicators of a pedestrian crossing ahead. The features existing around a vehicle further include, for example, illumination information on at least one traffic light, obstacles such as pylons, and poles installed in road shoulders.

The recognition unit 22 is configured to generate, based on the recognized features, feature data related to the recognized features.

The feature data generated by the recognition unit 22 includes at least one of (i) at least one dynamic data item related to a recognized feature, which can change over time, and (ii) at least one static data item related to a recognized feature, which do not change over time.

Such a dynamic data item of a recognized feature according to the exemplary embodiment includes, for example, operating information on the recognized feature. For example, if a recognized feature is a traffic light, the dynamic data item of the traffic light includes the illumination information on the traffic light.

The illumination information on a traffic light shows which of the lighting sections of the traffic light is illuminated. Each of the lighting sections of the traffic light means a portion of the traffic light that illuminates. Each of the lighting sections is comprised of, for example, a lamp, a lens, and a hood enclosing the lamp and the lens, and is configured to emit, through the lens, light generated from the lamp.

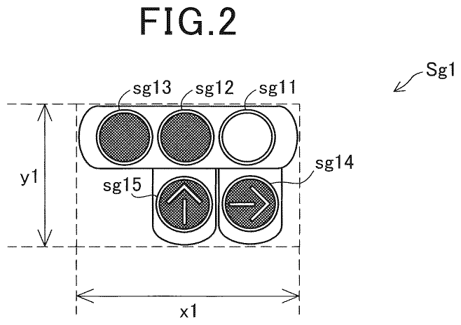

FIG. 2 illustrates an example of a traffic light Sg1 provided for a road.

The traffic light Sg1 has a main housing H1 that has a substantially rectangular-parallelepiped shape and two auxiliary housings H2 and H3, each of which has a substantially rectangular-parallelepiped shape. The main box housing H1 is located above the road while the longitudinal direction extends in parallel to the width direction of the road. Each of the two auxiliary housings H2 and H3 is mounted on the bottom of the main housing H1 while extending therefrom toward the road.

The traffic light Sg1, i.e., the main housing H1 thereof, has a predetermined lateral width x1. Similarly, the traffic light Sg1 has a predetermined vertical width y1 defined as a length from the top of the main housing H1 to the bottom of each auxiliary housing H2.

The traffic light sg1 includes three main lighting sections sg11, sg12, and sg13 installed in the main housing H1, and two auxiliary lighting sections sg14 and sg15 installed in the respective auxiliary 10) housings H2.

The main lighting section sg11 can be illuminated in red, the main lighting section sg12 can be illuminated in yellow, and the main lighting section sg13 can be illuminated in blue or green. The auxiliary lighting section sg14 can be illuminated in the shape of a rightward arrow, and the auxiliary lighting section sg15 can be illuminated in the shape of an upward arrow that indicates “go straight”.

For example, the illumination status of the lighting sections sg11 to sg15 illustrated in FIG. 2 shows that the main lighting section sg11 is illuminated in red, the auxiliary lighting section sg14 illustrated in FIG. 2 is luminated in the shape of the rightward arrow, and the auxiliary lighting section sg15 illustrated in FIG. 2 is illuminated in the shape of the upward arrow, i.e., the straight-ahead arrow. That is, the illumination status of the lighting sections sg11 to sg15 illustrated in FIG. 2 shows that straight-ahead vehicles and right-turning vehicles are allowed to go forward.

The illumination information on a traffic light according to the exemplary embodiment includes, for example, (i) the type of lighting of at least one of the lighting sections that is illuminated, (ii) the identification (ID) of the traffic light, and (iii) the positional information on the traffic light. The type of lighting of at least one of the lighting sections that is illuminated, the ID of the traffic light, and the positional information on the traffic light are handled as a dynamic data item according to the exemplary embodiment. To all traffic lights, which can be represented in the three-dimensional map data, predetermined identifications have been already assigned as their IDs.

Specifically, the positional information on each of the traffic lights and the ID of the corresponding one of the traffic lights are stored beforehand as traffic-light information in the storage device 30 while the positional information on each of the traffic lights correlates with the ID 10) of the corresponding one of the traffic lights.

The recognition unit 22 of each in-vehicle device 10 is configured to recognize, based on the measurements acquired by the sensors 60, a distance of each recognized feature, such as a recognized traffic light, from the corresponding vehicle and an orientation of each recognized feature with respect to the corresponding vehicle.

Then, the recognition unit 22 of each in-vehicle device 10 is configured to estimate the position of each recognized feature in accordance with (i) the current position of the corresponding vehicle measured by, for example, the GNSS receiver and (ii) the recognized distance and orientation of the corresponding recognized feature.

For example, the recognition unit 22 of each in-vehicle device 10 is configured to estimate the position of a recognized traffic light in accordance with (i) the current position of the corresponding vehicle measured by, for example, the GNSS receiver and (ii) the recognized distance and orientation of the recognized traffic light.

Each image captured by the at least one camera is comprised of two-dimensionally arranged pixels, i.e., light-intensity values or pixel values, corresponding to a two-dimensionally arranged light-sensitive elements of an image sensor of the at least one camera. The two-dimensionally arranged light-sensitive elements of the at least one camera correspond to, for example, a detectable region of the at least one camera.

Next, the recognition unit 22 of each in-vehicle device 10 is configured to refer to the traffic-light information stored in the storage device 30 to accordingly identify, based on the estimated position of the recognized traffic light and the traffic-light information, the ID of the traffic light.

The recognition unit 22 of each in-vehicle device 10 is configured to obtain, based on, for example, the pixel values of each image, i.e., each frame image, captured by the at least one camera, how the recognized traffic light illuminates.

In a case where the illumination status of the lighting sections sg11 to sg15 is illustrated in FIG. 2, the recognition unit 22 can generate, based on the measurements from the sensors 60, the following first to third dynamic data items:

The first dynamic data item (I) including the ID of the traffic light Sg1, the positional information on the traffic light Sg1, and the traffic light Sg1 indicating red light.

The second dynamic data item (II) including the ID of the traffic 20) light Sg1, the positional information on the traffic light Sg1, and the traffic light Sg1 indicating the rightward arrow.

The third dynamic data item (III) including the ID of the traffic light Sg1, the positional information on the traffic light Sg1, and the traffic light Sg1 indicating the straight-ahead arrow.

That is, the illumination information on the traffic light Sg1 includes the ID of the traffic light Sg1 and the positional information on the traffic light Sg1. For this reason, even if the server apparatus 200 acquires a part of the first to third dynamic data items of the traffic light Sg1 at a timing different from the timing at which the server apparatus 200 acquires the remaining of the first to third dynamic data items of the traffic light Sg1, the server apparatus 200 can be configured to identify the number of the lighting sections of the traffic light Sg1 and the color of each lighting section of the traffic light Sg1.

Each of the dynamic data items according to the exemplary embodiment may include, in addition to the corresponding illumination information on at least one traffic light, a timing information item indicative of the acquisition timing or recognition timing of the corresponding illumination information.

In this modification, even if the server apparatus 200 acquires dynamic data items related to a traffic light, which are acquired simultaneously at a timing, the server apparatus 200 can be configured to identify, based on the timing information items of the dynamic data items, the illumination status of the traffic light at the timing. For example, when receiving the first to third dynamic data items (I) to (III) related to the traffic light Sg1 acquired simultaneously, the server apparatus 200 can be configured to identify, based on the first to third dynamic data items (I) to (III) with the same ID of the traffic light Sg1 and the timing information items of the first to third dynamic data items (I) to (III), that (A) red-light illumination, (B) rightward arrow illumination, and (C) straight-ahead arrow illumination occur simultaneously in the traffic light Sg1.

Such a static data item according to the exemplary embodiment includes, for example, dimensional data indicative of the dimensions of a recognized feature, i.e., a recognized traffic light.

For example, when detecting the traffic light Sg1 illustrated in FIG. 2, the recognition unit 22 recognizes the lateral width x1 and the vertical width y1 of the traffic light Sg1 as the dimensional data of the traffic light Sg1. That is, when detecting the traffic light Sg1 illustrated in FIG. 2, the recognition unit 22 generates a static data item of the traffic light Sg1 including the ID, the positional information, the lateral width x1, and the vertical width y1 of the traffic light Sg1.

The recognition unit 22 of each in-vehicle device 10 can use one of known recognition methods. For example, the recognition unit 22 of each in-vehicle device 10 can recognize the types of one or more features existing around the corresponding vehicle using a known recognition method based on Convolution Neural Networks (CNN), You Only Look Once (YOLO), and/or Single Shot Multi-Box Detector (SSD). Alternatively, many patterns of each of natural/artificial features on or around roads can be stored in the storage device 30, and the recognition unit 22 of each in-vehicle device 10 can perform known pattern matching of the measurements from the sensors 60, such as the measured images of the at least one camera, with the patterns stored in the storage device 30 to accordingly recognize the types of one or more features existing around the corresponding vehicle.

The recognition unit 22 of each in-vehicle device 10 is configured to estimate a distance of each recognized feature from the corresponding vehicle using at least one of the following first to fifth distance estimation methods.

The first distance estimation method acquires, using a known SfM (Structure from Motion) method, a three-dimensional point cloud of a plurality of points constituting a recognized feature based on the pixel values of each image captured by the at least one camera; each of the plurality of points has coordinates in a predetermined three-dimensional coordinate system defined relative to the corresponding vehicle. Alternatively, the first distance estimation method acquires, using a detection point cloud of a plurality of detection points of a recognized feature measured by the one or more Lidar sensors, a three-dimensional point cloud of a plurality of points, each of which has coordinates in the predetermined three-dimensional coordinate system defined relative to the corresponding vehicle.

Then, the first distance estimation method estimates, based on the three-dimensional point cloud, the distance of the recognized feature from the corresponding vehicle.

The second distance estimation method identifies, based on the pixels of each image captured by the at least one camera, an apparent lateral width and/or an apparent vertical width of a recognized feature of a predetermined type appearing in the at least one image, such as a recognized traffic light. Then, the second distance estimation method compares the apparent lateral width and/or apparent vertical width of the recognized feature with the actual (original) lateral width and/or the actual (original) vertical width of the feature to accordingly estimate the distance of the recognized feature from the corresponding vehicle.

The third to fifth distance estimation methods represent known other distance estimation methods that are different from the first and second distance estimation methods. The number of the known other distance estimation methods is not limited to the three, and at least one known other distance estimation method may be prepared so that the recognition unit 22 of each in-vehicle device 10 may be configured to estimate a distance of each recognized feature from the corresponding vehicle selectably using one of the first distance estimation method, the second estimation method, and the at least one known other distance estimation method. Optionally, no other distance estimation methods different from the first and second distance estimation methods may be prepared.

The first to fifth distance estimation methods have different levels of reliability. Specifically, the level of reliability of the first distance estimation method is the highest in all the first to fifth distance estimation methods. The second, third, fourth, and fifth distance estimation methods decrease in reliability level in that order.

The recognition unit 22 of each in-vehicle device 10 according to the exemplary embodiment is configured to try estimation of a distance of each recognized feature from the corresponding vehicle using all the first to fifth distance estimation methods to accordingly acquire several distances estimated by corresponding several distance estimation methods included in the first to fifth distance estimation methods. Then, the recognition unit 22 of each in-vehicle device 10 according to the exemplary embodiment is configured to select one of the several estimated distances, the estimation method of which has the highest level of reliability, and recognize the selected estimated distance as a distance of each recognized feature from the corresponding vehicle.

The reliability of each of the first to fifth distance estimation methods will also be referred to as an estimation-method reliability.

The data acquisition unit 23 of each in-vehicle device 10 is configured to sequentially acquire the feature data recognized by the recognition unit 22 of the corresponding in-vehicle device 10. The data acquisition unit 23 of each in-vehicle device 10 is configured to acquire the feature data from the recognition unit 22 at regular intervals. Specifically, the data acquisition unit 23 of each in-vehicle device 10 is configured to acquire the feature data item from the recognition unit 22 every 100 milliseconds. The data acquisition unit 23 of each in-vehicle device 10 may be configured to acquire the feature data item from the recognition unit 22 every arbitrary interval.

The data acquisition unit 23 is additionally configured to acquire a level of the estimation-method reliability and a level of a housing-recognition reliability related to each feature data item from the recognition unit 22, which will be described later.

The transmission-target data determiner 24 of each in-vehicle device 10 is configured to determine, based on the feature data items sequentially acquired by the data acquisition unit 23, at least one feature data item as a transmission target to the server apparatus 200.

The transmission-target data generator 25 of each in-vehicle device 10 is configured to generate, based on one or more transmission targets determined by the transmission-target data determiner 24, transmission data as one or more data packets, each of which has a predetermined data size or data amount. For example, the data size of each data packet that the transmission-target data generator 25 of the exemplary embodiment generates is set to, for example, 1 kilobyte, but each data packet can have any data size.

The transmission-target data generator 25 of each in-vehicle device 10 is configured to transmit, to the data transmitter 50, the generated one or more data packets as the transmission data.

The data input unit 40 of each in-vehicle device 10 is configured to receive the measurements from the sensors 60. For example, the data input unit 40 of each in-vehicle device 10 is configured to communicate with the sensors 60 through an unillustrated Control Area Network (CAN) to retrieve, from the sensors 60, the measurements from the sensors 60. Alternatively, the data input unit 40 of each in-vehicle device may be configured to retrieve, from the sensors 60, the measurements from the sensors 60 through a dedicated communication line provided separately from the CAN.

The transmission data generating apparatus 11 of each in-vehicle device 10 included in the information collecting system 100 is configured to perform a feature data generation routine and a transmission-data generation routine described later. Executing the feature data generation routine and the transmission-data generation routine makes it possible to limit transmission of one or more feature data items, which have a relatively low reliability, to the server apparatus 200.

The following describes the feature data generation routine and the transmission-data generation routine.

### Feature-Data Generation Routine

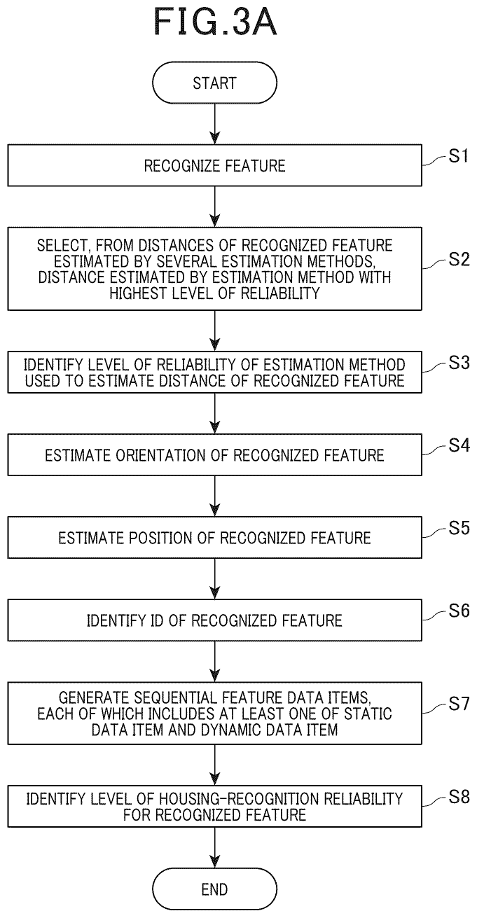

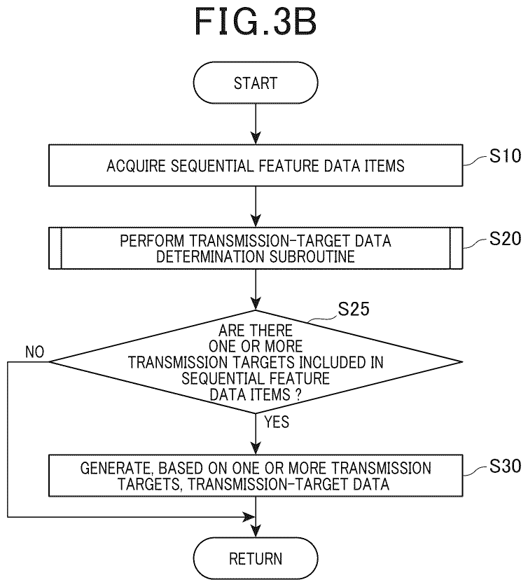

The CPU 20 of the transmission data generating apparatus 11 of each in-vehicle device 10 is programmed to cyclically execute the feature-data generation routine for generating feature data illustrated in FIG. 3A in response to the corresponding in-vehicle device 10 being powered on. While each in-vehicle device 10 is powered on, each of the sensors 60 of the corresponding vehicle is activated to continuously measure information related to the surrounding environment around the corresponding vehicle.

When starting the feature-data generation routine, the CPU 20 serves as, for example, the recognition unit 22 to successively recognize features existing around the corresponding vehicle based on the measurements successively acquired by the sensors 60 in step S1 of FIG. 3A.

Next, the CPU 20 serves as, for example, the recognition unit 22 to try, based on the measurements acquired by the sensors 60, an estimation of a distance of each recognized feature from the corresponding vehicle using all the first to fifth distance estimation methods to accordingly acquire several distances estimated by corresponding several distance estimation methods included in the first to fifth distance estimation methods in step S2. In step S2, the CPU 20 serves as, for example, the recognition unit 22 to select one of the several estimated distances, the estimation method of which has the highest level of reliability, and recognize the selected estimated distance as a distance of each recognized feature from the corresponding vehicle.

Following the operation in step S2, the CPU 20 serves as, for example, the recognition unit 22 to identify the level of estimation-method reliability of each recognized feature, which corresponds to the estimation method used to estimate the distance of the corresponding recognized feature from the corresponding vehicle in step S3.

Nine predetermined levels 1 to 9 of the estimation-method reliability have been prepared for the first to fifth distance estimation methods. For example, any one of the nine levels 1 to 9 of the estimation-method reliability has been set to each of the first to fifth distance estimation methods:

Level 9 of the estimation-method reliability is set to the first distance estimation method.

Level 8 of the estimation-method reliability is set to the second distance estimation method.

Level 6 of the estimation-method reliability is set to the third distance estimation method.

Level 2 of the estimation-method reliability is set to the fourth distance estimation method.

Level 1 of the estimation-method reliability is set to the fifth distance estimation method.

The level 9 of the estimation-method reliability is the highest in all the nine levels 1 to 9 of the estimation-method reliability, and the levels 8 to 1 of the estimation-method reliability successively decrease in this order.

That is, if the recognition unit 22 selects the distance of a recognized feature using the first distance estimation method, the recognition unit 22 identifies the level 9 of the estimation-method reliability for the recognized feature.

Following the operation in step S3, the CPU 20 serves as, for example, the recognition unit 22 to estimate, based on the measurements acquired by the sensors 60, an orientation of each recognized feature with respect to the corresponding vehicle in step S4.

Next, the CPU 20 serves as, for example, the recognition unit 22 to estimate the position of each recognized feature in accordance with (i) the current position of the corresponding vehicle measured by, for example, the GNSS receiver and (ii) the recognized distance and orientation of the corresponding recognized feature in step S5.

Following the operation in step S5, the CPU 20 serves as, for example, the recognition unit 22 to refer to the traffic-light information stored in the storage device 30 to accordingly identify, based on the estimated position of each recognized feature, the ID of the corresponding recognized feature in step S6.

Next, the CPU 20 serves as, for example, the recognition unit 22 to generate, for each recognized feature, a feature data item including at least one of (i) a dynamic data item and (ii) a static data item for the corresponding recognized feature in accordance with the ID of the corresponding recognized feature, the estimated position of the corresponding recognized feature, and the measurements successively acquired by the sensors 60 in step S7.

In particular, the CPU 20 serves as, for example, the recognition unit 22 to generate, for a traffic light as a recognized feature, a dynamic data item related to the traffic light, which includes (i) the ID of the traffic light, (ii) the positional information on the traffic light, and (iii) how the traffic light indicates light.

Additionally, the CPU 20 serves as, for example, the recognition unit 22 to generate, for a traffic light as a recognized feature, a static data item related to the traffic light, which includes (i) the ID of the traffic light, (ii) the positional information of the traffic light, and (iii) the dimensions, such as the lateral and vertical widths, of the traffic light.

Following the operation in step S7, the CPU 20 serves as, for example, the recognition unit 22 to identify a level of the housing-recognition reliability of each recognized feature in accordance with the type of the corresponding recognized feature in step S8; the type of each recognized feature can be identified based on the ID of the corresponding recognized feature.

The level of the housing-recognition reliability of any feature represents the level of reliability of the housing, i.e., the external form, of the feature itself.

For a feature, i.e., a geographic feature, having a predetermined shape, the level of reliability in estimating the position, dimensions, orientation, and/or type of the feature is higher than the level of reliability associated with estimating features that may exhibit various shapes.

For example, because traffic lights have predetermined shapes and sizes, the confidence in estimating their dimensions is high. Similarly, because landmarks have predetermined shapes and sizes, the confidence in estimating their dimensions is high.

From this viewpoint, the CPU 20 serves as, for example, the recognition unit 22 to identify the level of the housing-recognition reliability of each recognized feature in accordance with the type of the corresponding recognized feature in step S8.

In particular, predetermined eleven levels 0 to 10 of the housing-recognition reliability have been prepared for the various types of the features. Then, the CPU 20 serves as, for example, the recognition unit 22 to select, for each recognized feature, one of the eleven levels 0 to 10 of the housing-recognition reliability, which corresponds to the type of the corresponding recognized feature in step S8.

That is, the CPU 20 serves as, for example, the recognition unit 22 to generate each feature data item that correlates with (i) the level of the estimation-method reliability of the recognized feature included in the corresponding feature data item, and (ii) the level of the housing-recognition reliability level of the recognized feature included in the corresponding feature data item.

Following the operation in step S8, the CPU 20 terminates the feature-data generation routine. While each in-vehicle device 10 is powered on, the recognition unit 22 of the corresponding in-vehicle device 10 is programmed to cyclically perform the feature-data generation routine.

### Transmission-Data Generation Routine

The CPU 20 of the transmission data generating apparatus 11 of each in-vehicle device 10 is programmed to cyclically execute the transmission-data generation routine for generating transmission data illustrated in FIGS. 3B, 4, 5, and 8 in response to the corresponding in-vehicle device 10 being powered on.

When starting the transmission-data generation routine, the CPU 20 serves as, for example, the data acquisition unit 23 to sequentially retrieve, from the recognition unit 22, (i) feature data items recognized and generated thereby for each recognized feature, (ii) the level of the estimation-method reliability correlating with the corresponding one of the feature data items, and (iii) the level of the housing-recognition reliability correlating with the corresponding one of the feature data items in step S10 of FIG. 3B. The data acquisition unit 23 retrieves, from the recognition unit 22, one feature data item from the recognition unit 22 every 100 milliseconds.

Each of the feature data items for each recognized feature includes at least one of a static data item and a dynamic data item related to the corresponding recognized feature.

In step S10, the CPU 20 serves as, for example, the data acquisition unit 23 to temporarily store (i) the sequential feature data items for each recognized feature, (ii) the level of the estimation-method reliability correlating with the corresponding one of the sequential feature data items, and (iii) the level of the housing-recognition reliability correlating with the corresponding one of the sequential feature data items in the internal memory 20a. In place of the internal memory 20a, the CPU 20 serves as, for example, the data acquisition unit 23 to temporarily store them in the storage device 30.

Next, the CPU 20 serves as, for example, the transmission-target data determiner 24 to execute a transmission-target data determination subroutine in step S20. The transmission-target data determination subroutine in step S20 decides whether to selectably determine a static data item and/or a dynamic data item included in the sequential feature data items for each recognized feature retrieved in step S10 as the transmission-target in step S20.

That is, the transmission-target data determination subroutine is capable of deciding not to selectably determine all data items included in the sequential feature data items for each recognized feature retrieved in step S10 as the transmission-target in step S20.

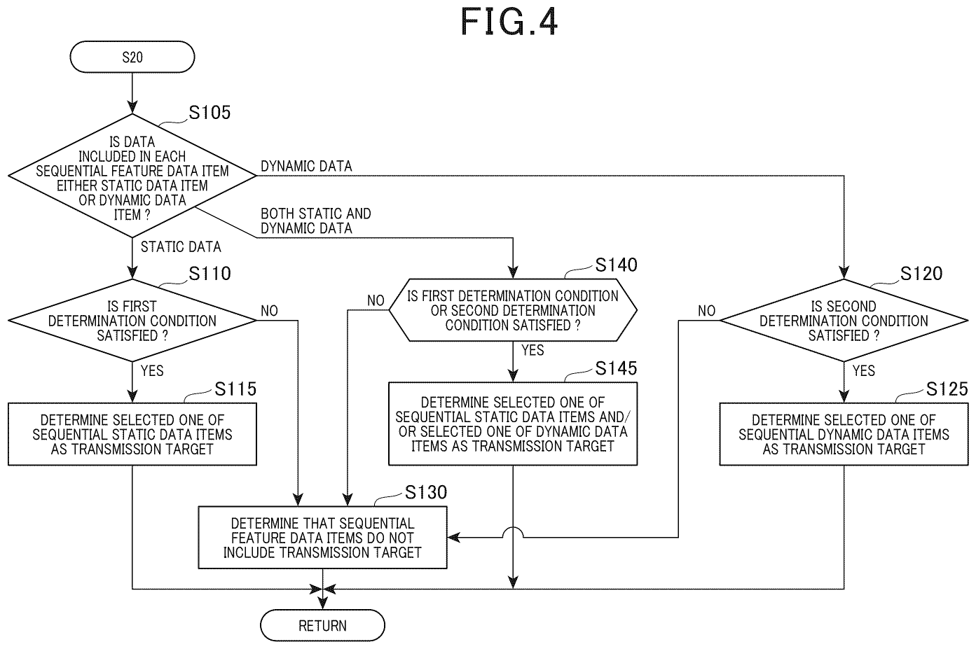

FIG. 4 illustrates specific operations in steps S105 to S130 of the transmission-target data determination subroutine.

Specifically, when starting the transmission-target data determination subroutine in step S20 of the transmission data generation routine, the CPU 20 serves as, for example, the transmission-target data determiner 24 to determine whether data included in each of the sequential feature data items for each recognized feature retrieved in step S10 is either a static data item or a dynamic data item in step S105.

In other words, the CPU 20 serves as, for example, the transmission-target data determiner 24 to
(I) Select one of the recognized features as a determination target feature,
(II) Perform a determination as to whether data included in each of the sequential feature data items for each recognized feature retrieved in step S10 is either a static data item or a dynamic data item in step S105, and
(III) Iterate the determination in step S105 until all the recognized features have been selected as the determination target feature

In response to determination that data included in each of the sequential feature data items for each recognized feature retrieved in step S10 is a static data item (“static data” in step S105), the transmission-target data determination subroutine proceeds to step S110.

In step S110, the CPU 20 serves as, for example, the transmission-target data determiner 24 to perform a first determination task of determining whether a predetermined first determination condition for identifying one of the sequential static data items as the transmission target is satisfied.

In response to determination that the predetermined first determination condition for identifying one of the sequential static data items as the transmission target is satisfied (YES in step S110), the CPU 20 serves as, for example, the transmission-target data determiner 24 to determine, as the transmission target, the one of the sequential static data items corresponding to the determination target feature in step S115.

Otherwise, in response to determination that the predetermined first determination condition for identifying one of the sequential static data items as the transmission target is not satisfied (NO in step S110), the CPU 20 serves as, for example, the transmission-target data determiner 24 to determine that the sequential static data items corresponding to the determination-target feature do not include the transmission target in step S130.

The first determination task in step S110 will be described in detail later.

Otherwise, in response to determination that data included in each of the sequential feature data items for each recognized feature retrieved in step S10 is a dynamic data item (“dynamic data” in step S105), the transmission-target data determination subroutine proceeds to step S120.

In step S120, the CPU 20 serves as, for example, the transmission-target data determiner 24 to perform a second determination task of determining whether a predetermined second determination condition for identifying one of the sequential feature data items, i.e., the sequential dynamic data items, as the transmission target is satisfied.

In response to determination that the predetermined second 10) determination condition for identifying one of the sequential dynamic data items as the transmission target is satisfied (YES in step S120), the CPU 20 serves as, for example, the transmission-target data determiner 24 to determine, as the transmission target, the one of the sequential dynamic data items corresponding to the determination target feature in step S125.

Otherwise, in response to determination that the predetermined second determination condition for identifying one of the sequential dynamic data items as the transmission target is not satisfied (NO in step S120), the CPU 20 serves as, for example, the transmission-target data determiner 24 to determine that the sequential dynamic data items corresponding to the determination-target feature do not include the transmission target in step S130.

The second determination task in step S120 will be described in detail later.

In response to determination that each of the sequential feature data items corresponding to the determination target feature retrieved in step S10 includes both a static data item and a dynamic data item (“both static and dynamic data” in step S105), the transmission-target data determination subroutine proceeds to step S140.

In step S140, the CPU 20 serves as, for example, the transmission-target data determiner 24 to perform
(I) A first determination task of determining whether the predetermined first determination condition for identifying one of the sequential static data items as the transmission target is satisfied, and
(II) A second determination task of determining whether the predetermined second determination condition for identifying one of the sequential dynamic data items as the transmission target is satisfied

In response to determination that the predetermined first determination condition for identifying one of the sequential static data items as the transmission target is satisfied (YES in the first determination of step S140), the CPU 20 serves as, for example, the transmission-target data determiner 24 to determine, as the transmission target, the one of the sequential static data items corresponding to the determination target feature in step S145.

Additionally, in response to determination that the predetermined second determination condition for identifying one of the sequential dynamic data items as the transmission target is satisfied (YES in the second determination of step S140), the CPU 20 serves as, for example, the transmission-target data determiner 24 to determine, as the transmission target, the one of the sequential dynamic data items corresponding to the determination target feature in step S145.

Otherwise, in response to determination that neither the predetermined first determination condition nor the predetermined second determination condition is satisfied (NO in step S140), the CPU 20 serves as, for example, the transmission-target data determiner 24 to determine that (i) the sequential static data items corresponding to the determination-target feature do not include the transmission target, and (ii) the sequential dynamic data items corresponding to the determination-target feature do not include the transmission target in step S130.

The transmission-target data determination subroutine in step S20 for the sequential feature data items corresponding to the determination target feature is iterated until all the recognized features have been selected as the determination target feature.

After completion in step S20, the CPU 20 returns to the main routine, i.e., the transmission data generation routine. Then, the CPU 20 serves as, for example, the transmission-target data determiner 24 to determine whether there are one or more of the transmission targets included in the sequential feature data items for at least one recognized feature in step S25.

In response to determination that there are one or more of the transmission targets included in the sequential feature data items for at least one recognized feature (YES in step S25), the CPU 20 serves as, for example, the transmission-target data generator 25 to generate, based on the one or more of the transmission targets, transmission target data.

Specifically, in response to determination that there are one or more of the transmission targets included in the sequential feature data items for at least one recognized feature (YES in step S25), the CPU 20 serves as, for example, the transmission-target data generator 25 to encapsulate the transmission targets in at least one data packet to accordingly generate the at least one data packet in step S30. Thereafter, the CPU 20 terminates the current cycle of the transmission-data generation routine.

Otherwise, in response to determination that there are no transmission targets included in the sequential feature data items for each at least one recognized feature (NO in step S25), the CPU 20 terminates the current cycle of the transmission-data generation routine, and returns to the operation in step S10 of the next cycle of the transmission-data generation routine.

### Detailed Description of Subroutine in Step S110

Next, the following describes, in detail, the first determination task of determining whether the predetermined first determination condition related to the sequential static data items corresponding to the determination target feature is satisfied.

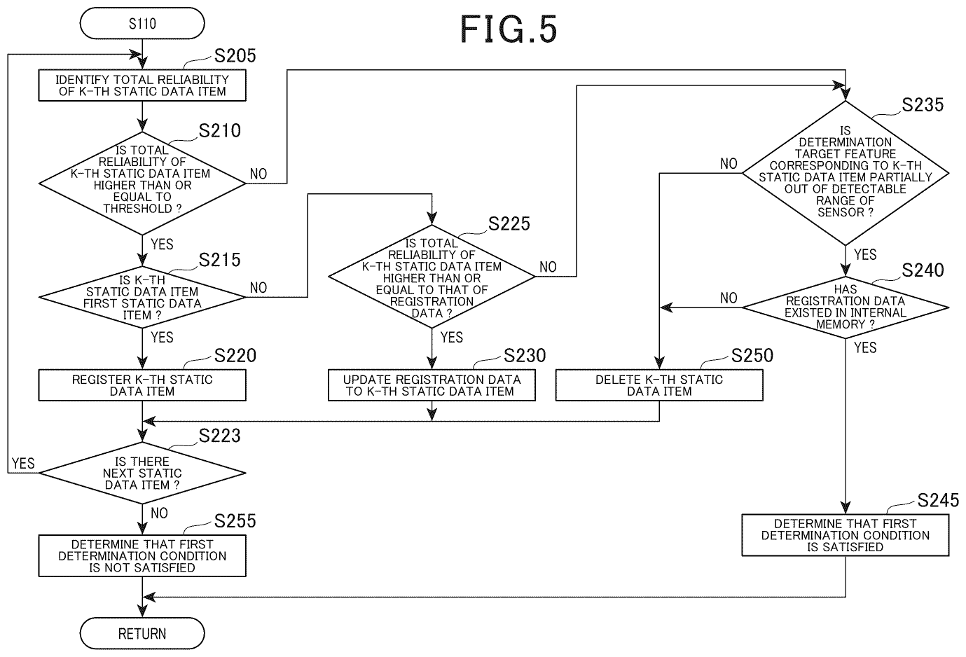

The first determination task in step S110 includes, as illustrated in FIG. 5, the following operations in steps S205 to S255.

When starting the first determination task in step S110, the CPU 20 serves as, for example, the transmission-target data determiner 24 to identify a total reliability of a k-th static data item of the sequential static data items in step S205; k is a parameter of a natural number whose initial number is set to 1. That is, the CPU 20 serves as, for example, the transmission-target data determiner 24 to identify the total reliability of the 1-th (first) static data item in the sequential static data items in step S205.

The total reliability of any static data item represents the level of reliability as an indicator for accuracy of the static data item.

The total reliability of any static data item according to the exemplary embodiment is identified based on (i) the level of the 20) estimation-method reliability and (ii) the level of the housing-recognition reliability of the static data item. More specifically, the total reliability of any static data item according to the exemplary embodiment is identified based on the product of (i) the level of the estimation-method reliability and (ii) the level of the housing-recognition reliability of the static data item.

Specifically, the CPU 20 serves as, for example, the transmission-target data determiner 24 to identify (i) the level of the estimation-method reliability and (ii) the level of the housing-recognition reliability correlating with the k-th static data item of the sequential static data items in step S205.

Then, the CPU 20 serves as, for example, the transmission-target data determiner 24 to multiply one of the level of the estimation-method reliability and (ii) the level of the housing-recognition reliability by the other thereof to accordingly calculate the total reliability of the k-th static data item in step S205.

After completion of the operation in step S205, the CPU 20 serves as, for example, the transmission-target data determiner 24 to determine whether the total reliability of the k-th static data item is higher than or equal to a predetermined threshold in step S210. The predetermined threshold according to the exemplary embodiment is set to 32 according to the exemplary embodiment. This aims to separate (i) static data items, each of which is related to a recognized feature whose distance is estimated by the first distance estimation method or the second distance estimation method and whose level of the housing-recognition reliability is higher than or equal to 4 from (ii) the other static data items.

In response to determination that the total reliability of the k-th static data item is higher than or equal to the predetermined threshold (YES in step S210), the CPU 20 serves as the transmission-target data determiner 24 to determine whether the k-th static data item of the sequential static data items is a first static data item initially generated for the determination target feature when the determination target feature appears within a predetermined detectable region of a selected sensor for monitoring the determination target feature in the sensors 60, such as the front camera, in step S215.

In response to determination that the k-th static data item of the sequential static data items is the first static data item initially generated for the determination target feature (YES in step S215), the CPU 20 serves as, for example, the transmission-target data determiner 24 to register the k-th static data item of the sequential static data items in step S220.

Registering data in step S220 represents keeping the data distinguishable from the other data. For example, the transmission-target data determiner 24 can be configured to store addresses of a storage region of the internal memory 20a in which the registered static data item is stored in another storage region of the internal memory 20a.

The static data item registered in step S220 will also be referred to as a registration data item.

After completion in step S220, the CPU 20 serves as, for example, the transmission-target data determiner 24 to determine whether there is a next static data item in step S223. If there is a next static data item next to the k-th static data item, the determination in step S223 is YES. Then, the CPU 20 serves as, for example, the transmission-target data determiner 24 to increment the parameter k by 1, returns to the operation in step S205, and performs the operation in step S205 for the k-th static data item.

Otherwise, in response to determination that the k-th static data item of the sequential static data items is not the first static data item initially generated for the determination target feature (NO in step S215), the CPU 20 serves as, for example, the transmission-target data determiner 24 to determine whether the total reliability of the k-th static data item is higher than or equal to that of the registration data item in step S225.

In response to determination that the total reliability of the k-th static data item is higher than or equal to that of the registration data item (YES in step S225), the CPU 20 serves as, for example, the transmission-target data determiner 24 to update the registration data item to the k-th static data item in step S230.

After completion of the operation in step S230, the CPU 20 serves as, for example, the transmission-target data determiner 24 to determine whether there is a next static data item in step S223.

In response to determination that there is a next static data item next to the k-th static data item (YES in step S223), the CPU 20 serves as, for example, the transmission-target data determiner 24 to increment the parameter k by 1, returns to the operation in step S205, and performs the operation in step S205 for the k-th static data item.

Otherwise, in response to determination that the total reliability of the k-th static data item is lower than that of the registration data item (NO in step S225), the CPU 20 serves as, for example, the transmission-target data determiner 24 to determine whether the determination target feature corresponding to the k-th static data item is partially out of the predetermined detectable region of the selected sensor, such as the front camera, in step S235.

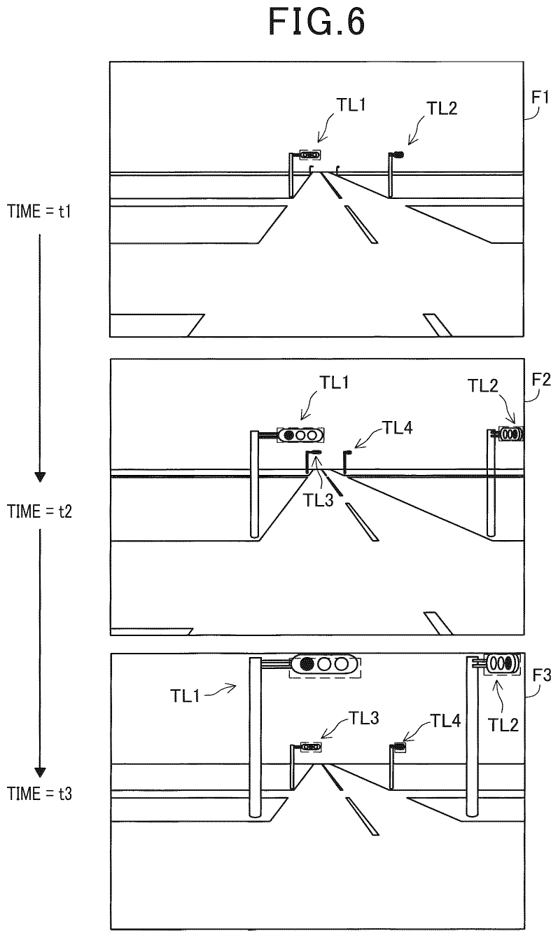

For example, FIG. 6 is an image sequence diagram illustrating the sequence of images captured by, for example, the front camera of a vehicle at sequential times t1, t2, and t3. The top portion of FIG. 6 illustrates a frame image F1 captured by the at least one camera at the time t1, the middle portion of FIG. 6 illustrates a frame image F2 captured by the time t2, and the bottom portion of FIG. 6 illustrates a frame image 20) F3 captured by the time t3. That is, each of the frame images 11, 12, and 13 is an image of the detectable region of the front camera located at the corresponding one of the times t1, t2, and t3.

In the frame image F1 captured at the time t1, two traffic lights TL1 and TL2 appear, and the traffic light TL1 is recognized by the recognition unit 22 as a “traffic light”.

In the frame image F2 captured at the time t2 later than the time t1, the two traffic lights TL1 and TL2 appear, the size of each of which is greater than that in the frame image F1, because the vehicle has moved ahead. In the frame image F2, two traffic lights TL3 and TL4 newly appear; the traffic lights TL3 and TL4 are located farther away from the vehicle than the traffic lights TL1 and TL2 are. In the frame image F2, the traffic light TL1 is also recognized by the recognition unit 22 as a “traffic light”.

In the frame image F3 captured at the time t3 later than the time t2, each of the traffic lights TL1, TL2, TL3, and TL4 appear, the size of each of which is greater than that in the frame image F2, because the vehicle has moved ahead. In particular, the top of each of the traffic lights TL1 and TL2 is partially out of the frame image F3. That is, each recognized traffic light TL1, TL2 has been partially excluded from the predetermined detectable region of the front camera, resulting in the level of the housing-recognition reliability of each of the recognized traffic light TL1, TL2 decreasing.

In response to determination that the determination target feature corresponding to the k-th static data item is included in the predetermined detectable region of the front camera (NO in step S235), the CPU 20 serves as, for example, the transmission-target data determiner 24 to delete the k-th static data item in step S250. Then, the CPU 20 serves as, for example, the transmission-target data determiner 24 to determine whether there is a next static data item in step S223.

In response to determination that there is a next static data item next to the k-th static data item (YES in step S223), the CPU 20 serves as, for example, the transmission-target data determiner 24 to increment the parameter k by 1, returns to the operation in step S205, and performs the operation in step S205 for the k-th static data item.

As described above, the situation where the determination target feature is partially out of the predetermined detectable region of the selected sensor, such as the front camera, represents that the determination target feature is partially excluded from the predetermined detectable region of the selected sensor, such as the front camera. That is, as illustrated by the frame image F3, at least part of a recognized feature, such as the traffic light TL1 or TL2, is not captured in the frame image F3.

Otherwise, in response to determination that the determination target feature is out of the predetermined detectable region of the front camera (YES in step S235), the CPU 20 proceeds to step S240.

In step S240, the CPU 20 serves as, for example, the transmission-target data determiner 24 to determine whether the registration data item corresponding to the determination target feature data has existed in the internal memory 20a in step S240.

That is, if the total reliability of any of the sequential static data items is lower than the predetermined threshold while the determination target feature is within the detectable range of the selected sensor, such as the front camera (i.e., from the time the target determination feature appears within the detectable region until it exits the detectable region), then no registration data item related to the target determination feature is generated.

In contrast, if the total reliability of one of the sequential static data items is higher than or equal to the predetermined threshold while the determination target feature is within the detectable range of the selected sensor, such as the front camera, then the one of the sequential 20 static data items is registered as the registration data item.

In response to determination that the registration data item corresponding to the determination target feature data has existed in the internal memory 20a (YES in step S240), the CPU 20 serves as, for example, the transmission-target data determiner 24 to determine that the first determination condition related to the sequential static data items is satisfied in step S245.

That is, the determination in step S110 is YES. Then, the CPU 20, which returns to the operation in step S135, serves as, for example, the transmission-target data determiner 24 to determine, as the transmission target, the registration data item, i.e., the registered static data item, included in the sequential static data items corresponding to the determination target feature in step S115. Then, the CPU 20, which returns to the operation in step S30, serves as, for example, the transmission-target data generator 25 to encapsulate the registered static data item in at least one data packet to accordingly generate, as the transmission-target data, the at least one data packet in step S30.

Otherwise, in response to determination that no registration data item corresponding to the determination target feature data has existed in the internal memory 20a (NO in step S240), the CPU 20 serves as, for example, the transmission-target data determiner 24 to delete the k-th static data item in step S250. Then, the CPU 20 serves as, for example, the transmission-target data determiner 24 to determine whether there is a next static data item in step S223.

In response to determination that there is a next static data item next to the k-th static data item (YES in step S223), the CPU 20 serves as, for example, the transmission-target data determiner 24 to increment the parameter k by 1, returns to the operation in step S205, and performs the operation in step S205 for the k-th static data item.

Otherwise, in response to determination that there is not a next static data item next to the k-th static data item (NO in step S223), the CPU 20 serves as, for example, the transmission-target data determiner 24 to determine that the predetermined first determination condition related to the sequential static data items is not satisfied in step S255. That is, the determination in step S110 is NO. Then, the CPU 20, which returns to the operation in step S130, serves as, for example, the transmission-target data determiner 24 to determine that the sequential static data items corresponding to the determination target feature include no transmission targets in step S130.

As can be understood by the descriptions of the subroutine in step S110, the first determination condition related to the sequential static data items corresponding to the determination target feature includes a third determination condition that one of selected static data items within a predetermined range in the sequential data items satisfies the following first and second requirements (i) and (ii):

The first requirement (i) is that the total reliability of the one of the selected static data items is higher than or equal to the predetermined threshold.

The second requirement (ii) is that the total reliability of the one of the selected static data items is the highest among all the selected static data items within the predetermined range in the sequential static data items; the selected static data items within the predetermined range are acquired from the time when the recognized feature appears within the predetermined detectable region of the selected sensor, until it is out of the predetermined detectable region of one of the sensors 60.

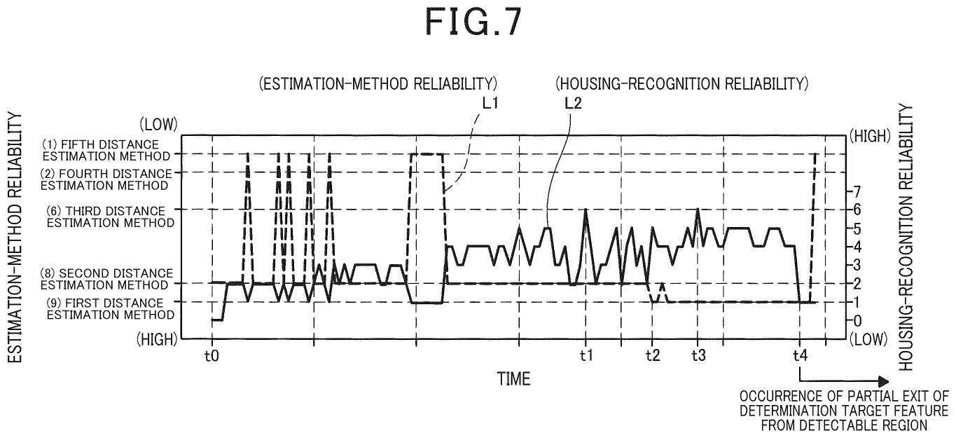

The graph of FIG. 7 has the horizontal axis representing time, the vertical axis at the left side representing the estimation-method reliability, and the vertical axis at the right side representing the housing-recognition reliability.

A dashed curve L1 in the graph shows the temporal variation of the estimation-method reliability of the sequential static data items corresponding to a determination target feature, and a solid curve L2 in the graph shows the temporal variation of the housing-recognition reliability of the sequential static data items corresponding to the determination target feature.

After time to, the temporal variation of the estimation-method reliability includes repeated increases and decreases. This is because, for example, a part of the determination target feature is obscured by buildings and/or trees, resulting in the housing-recognition reliability of the determination target feature repeatedly decreasing. This may be due to variations in background illumination.

For example, the estimation-method reliability of the determination target feature corresponding to the static data item obtained at time t1 significantly increases up to the level 6, and therefore the total reliability of the static data item obtained at the time t1 reaches the level 48, which exceeds the maximum value observed up to the time t1. For this reason, at least in the time t1, the operation in step S230 is carried out so that registration data item stored before the time t1 is updated to the static-data item obtained at the time t1.

At time t2, the estimation-method reliability of the determination target feature corresponding to the static data item obtained at the time t2 increases from the level 8 corresponding to the second distance estimation method to the level 9 corresponding to the first distance estimation method. Thereafter, the housing-recognition reliability of the determination target feature corresponding to the static data item obtained at time t3 increases up to the level 6, and therefore the total reliability of the static data item obtained at the time t3 reaches the level 54, which exceeds the maximum value 48 observed up to the time t3. For this reason, the operation in step S230 is carried out at the time t3 so that registration data item stored before the time t3 is updated to the static-data item obtained at the time t3.

After the time t3, the determination target feature corresponding to the static data item obtained at time t4 is partially out of the predetermined detectable region of the selected sensor, such as the front camera, so that the housing-recognition reliability of the determination target feature corresponding to the static data item obtained at the time t4 decreases down to the level 1.

That is, in the above example illustrated in FIG. 7, the registration data item, i.e., the static data item obtained at the time t3, is determined as the transmission target, and the registration data item, i.e., the static data item obtained at the time t3, is encapsulated in at least one data packet as the transmission-target data.

FIG. 7 clearly shows that the levels of the total reliability of the static data items change over time although they do not change over time.

From this viewpoint, the transmission data generating apparatus 11 of each in-vehicle device 10 according to the exemplary embodiment is configured to identify, as the transmission target, one of selected static data items within the predetermined range in the sequential data items in accordance with the third determination condition included in the first determination condition, which includes the following first and second requirements (i) and (ii):

The first requirement (i) is that the total reliability of the one of the selected static data items is higher than or equal to the predetermined threshold.

The second requirement (ii) is that the total reliability of the one of the selected static data items is the highest among all the selected static data items within the predetermined range in the sequential static data items; the selected static data items within the predetermined range are acquired from the time when the recognized feature appears within the predetermined detectable region of the selected sensor, until it is out of the predetermined detectable region of one of the sensors 60.

As can be understood by the descriptions of the subroutine in step S110, the first determination condition related to the sequential static data items corresponding to the determination target feature includes a third determination condition that one of selected static data items within the predetermined range in the sequential data items satisfies the following first and second requirements (i) and (ii):

The first requirement (i) is that the total reliability of the one of the selected static data items is higher than or equal to the predetermined threshold.

The second requirement (ii) is that the total reliability of the one of the selected static data items is the highest among all the selected static data items within the predetermined range in the sequential static data items; the selected static data items within the predetermined range are acquired from the time when the recognized feature appears within the predetermined detectable region of the selected sensor, until it is out of the predetermined detectable region of one of the sensors 60.

This therefore makes it possible to select one of the static data items corresponding to a recognized feature, which has a higher reliability other than any other static data items.

### Detailed Description of Subroutine in Step S120

Next, the following describes, in detail, the second determination task of determining whether the predetermined second determination condition related to the sequential dynamic data items corresponding to the determination target feature is satisfied.

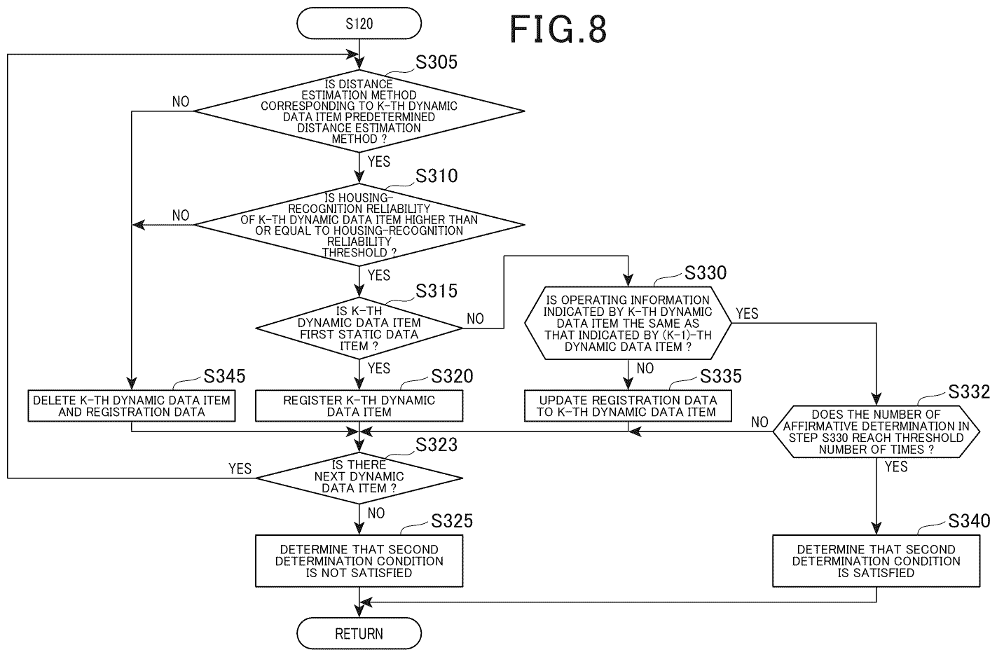

The second determination task in step S120 includes, as illustrated in FIG. 8, the following operations in steps S305 to S345.

When starting the second determination task in step S120, the CPU 20 serves as, for example, the transmission-target data determiner 24 to determine whether the distance estimation method used for the distance estimation of the determination target feature corresponding to a k-th dynamic data item of the sequential dynamic data items is a predetermined distance estimation method in step S305; k is the 25 parameter of the natural number whose initial number is set to 1.

The predetermined distance estimation method is a previously selected one of the first to fifth distance estimation methods, which is a method that is recognized as having higher reliability than the other distance estimation methods, depending on the type of the determination target feature. For example, the first distance estimation method is set as the predetermined distance estimation method.

In response to determination that the distance estimation method used for the distance estimation of the determination target feature corresponding to the k-th dynamic data item of the sequential dynamic data items is the predetermined distance estimation method (YES in step S305), the CPU 20 serves as, for example, the transmission-target data determiner 24 to determine whether the level of the housing-recognition reliability corresponding to the k-th dynamic data item is higher than or equal to a predetermined housing-recognition reliability threshold in step S310.

In response to determination that the level of the housing-recognition reliability corresponding to the k-th dynamic data item is higher than or equal to the predetermined housing-recognition reliability threshold (YES in step S310), the CPU 20 serves as the transmission-target data determiner 24 to determine whether the k-th dynamic data item of the sequential dynamic data items is a first dynamic data item initially generated for the determination target feature when the determination target feature appears within the predetermined detectable region of the selected sensor, such as the front camera, in step S315.

In response to determination that the k-th dynamic data item of the sequential dynamic data items is the first dynamic data item initially generated for the determination target feature (YES in step S315), the CPU 20 serves as, for example, the transmission-target data determiner 24 to register the k-th dynamic data item of the sequential dynamic data items in step S320. Registering data in step S320 represents keeping the data distinguishable from the other data.

The dynamic data item registered in step S320 will also be referred to as a registration data item.

After completion in step S320, the CPU 20 serves as, for example, the transmission-target data determiner 24 to determine whether there is a next dynamic data item in step S323. If there is a next dynamic data item next to the k-th dynamic data item, the determination in step S323 is YES. Then, the CPU 20 serves as, for example, the transmission-target data determiner 24 to increment the parameter k by 1, returns to the operation in step S305, and performs the operation in step S305 for the k-th dynamic data item.

Otherwise, in response to determination that the k-th dynamic data item of the sequential dynamic data items is not the first dynamic data item initially generated for the determination target feature (NO in step S315), the subroutine proceeds to step S330.

In step S330, the CPU 20 serves as, for example, the transmission-target data determiner 24 to determine whether the operating information indicated by the k-th dynamic data item is the same as that indicated by the (k−1)-th dynamic data item.

For example, if the determination target feature is a traffic light, the CPU 20 serves as, for example, the transmission-target data determiner 24 to determine whether the illumination information indicated by the k-th dynamic data item is the same as the illumination information indicated by the (k−1)-th dynamic data item.

In response to determination that the operating information indicated by the k-th dynamic data item is not the same as that indicated by the (k−1)-th dynamic data item (NO in step S330), the CPU 20 serves as, for example, the transmission-target data determiner 24 to update the registration data to the k-th dynamic data item in step S335. Thereafter, the subroutine proceeds to step S323.

Otherwise, in response to determination that the operating information indicated by the k-th dynamic data item is the same as that indicated by the (k−1)-th dynamic data item (YES in step S330), the CPU 20 serves as, for example, the transmission-target data determiner 24 to determine whether the number of the affirmative determination in step S330 reaches a predetermined threshold number of times in step S332.

In response to determination that the number of the affirmative determination in step S330 does not reach the predetermined threshold number of times (NO in step S332), the subroutine proceeds to step S323.

In step S323, the CPU 20 serves as, for example, the transmission-target data determiner 24 to determine whether there is a next dynamic data item. If there is a next dynamic data item next to the k-th dynamic data item, the determination in step S323 is YES. Then, the CPU 20 serves as, for example, the transmission-target data determiner 24 to increment the parameter k by 1, returns to the operation in step S305, and performs the operation in step S305 for the k-th dynamic data item.

Otherwise, in response to determination that the number of the affirmative determination in step S330 reaches the predetermined threshold number of times (YES in step S332), the CPU 20 serves as, for example, the transmission-target data determiner 24 to determine that the second determination condition related to the sequential dynamic 20) data items is satisfied in step S340.

That is, the determination in step S110 is YES. Then, the CPU 20, which returns to the operation in step S135, serves as, for example, the transmission-target data determiner 24 to determine, as the transmission target, the k-th dynamic data item included in the sequential dynamic data items corresponding to the determination target feature in step S115. Then, the CPU 20, which returns to the operation in step S30, serves as, for example, the transmission-target data generator 25 to encapsulate the registered dynamic data item in at least one data packet to accordingly generate, as the transmission-target data, the at least one data packet in step S30.

Otherwise, in response to determination that the distance estimation method used for the distance estimation of the determination target feature corresponding to the k-th dynamic data item of the sequential dynamic data items is not the predetermined distance estimation method (NO in step S305), the CPU 20 serves as, for example, the transmission-target data determiner 24 to delete the k-th dynamic data item and the registration data item in step S345. Then, the CPU 20 serves as, for example, the transmission-target data determiner 24 to determine whether there is a next dynamic data item in step S323.

In response to determination that there is a next dynamic data item next to the k-th dynamic data item (YES in step S323), the CPU 20 serves as, for example, the transmission-target data determiner 24 to increment the parameter k by 1, returns to the operation in step S305, and performs the operation in step S305 for the k-th dynamic data item.

Otherwise, in response to determination that there is not a next dynamic data item next to the k-th dynamic data item (NO in step S323), the CPU 20 serves as, for example, the transmission-target data determiner 24 to determine that the predetermined second determination condition related to the sequential dynamic data items is not satisfied in step S355. That is, the determination in step S110 is NO. Then, the CPU 20, which returns to the operation in step S130, serves as, for example, the transmission-target data determiner 24 to determine that the sequential dynamic data items corresponding to the determination target feature include no transmission targets in step S130.

As can be understood by the descriptions of the subroutine in step S120, the second determination condition related to the sequential dynamic data items corresponding to the determination target feature includes a fourth determination condition that a selected one of the sequential dynamic data items satisfies the following third to fifth requirements (iii) to (iv):

The third requirement (iii) is that the distance estimation method used for the distance estimation of the determination target feature corresponding to the selected one of the sequential dynamic data items is the predetermined distance estimation method.

The fourth requirement (iv) is that the level of the housing-recognition reliability corresponding to the selected one of the sequential dynamic data items is higher than or equal to the predetermined housing-recognition reliability threshold.

The fifth requirement (v) is that the number of consecutive data items, including the selected one of the sequential dynamic data items and preceding dynamic data items that indicate the same operating information, is greater than or equal to a predetermined threshold.

The fourth determination condition including the third to fifth requirements shows a condition as to whether the consecutive data items, which include the selected dynamic data item and preceding dynamic data items, are stable for a predetermined period.

Any dynamic data item, i.e., the operating information included in any dynamic data item on a recognized feature, can instantaneously vary due to disturbance. Specifically, there may be a situation where the main lighting section sg11 of the traffic light, which is not illuminated, is mistakenly recognized to be instantaneously illuminated by the recognition unit 22 due to reflection of sunlight by the main lighting section sg11. Such a misrecognition, however, can be eliminated with movement of the vehicle, so that the main lighting section sg11 can be correctly recognized, after a lapse of short time, to be not illuminated by the recognition unit 22 when there is no reflection of sunlight by the main lighting section sg11.

From this viewpoint, the data packet generation apparatus 11 of each in-vehicle device 10 according to the exemplary embodiment is configured to determine, as the transmission target, a selected one of the dynamic data items corresponding to a recognized feature in accordance with the fourth determination condition, which is included in the second determination condition, which includes the following third to fifth requirements (iii), (iv), and (v):

The third requirement (iii) is that the distance estimation method used for the distance estimation of the determination target feature corresponding to the selected one of the sequential dynamic data items is the predetermined distance estimation method.

The fourth requirement (iv) is that the level of the housing-recognition reliability corresponding to the selected one of the sequential dynamic data items is higher than or equal to the predetermined housing-recognition reliability threshold.

The fifth requirement (v) is that the number of consecutive data items, including the selected one of the sequential dynamic data items and preceding dynamic data items that indicate the same operating information, is greater than or equal to the predetermined threshold. The fourth determination condition including the third to fifth requirements shows a condition as to whether the consecutive data items, which include the selected dynamic data item and preceding dynamic 20) data items, are stable for a predetermined period.

This makes it possible to determine a selected dynamic data item included in the sequential dynamic data items, which has a high level of reliability and has been stable for the predetermined period, as the transmission target.

The transmission data generating apparatus 11 of each in-vehicle device 10 according to the exemplary embodiment is configured to
(I) Determine, when acquiring sequential static data items as sequential feature data items for a recognized feature, one of the sequential static data items in accordance with the first determination condition, and
(II) Determine, when acquiring sequential dynamic data items as the sequential feature data items for a recognized feature, one of the sequential dynamic data items in accordance with the second determination condition that is different from the first determination condition.

This makes it possible to
(I) Determine, as the first determination condition for the sequential static data items, a condition that enables selection of a static data item with a high level of reliability from the sequential static data items, and
(II) Determine, as the second determination condition for the sequential dynamic data items, a condition that enables selection of a dynamic data item with a high level of reliability from the sequential static data items

This therefore makes it possible to generate the transmission-target data based on the static data item and/or the dynamic data item, each of which has a higher level of reliability, thus limiting transmission of one or more feature data items, which have a relatively low reliability.

The first determination condition is based on both the estimation-method reliability and the housing-recognition reliability. This therefore makes it possible to determine, as the transmission-target data, one of the sequential static data items having a higher level of reliability, which satisfies both the estimation-method reliability and the housing-recognition reliability.

In particular, the transmission data generating apparatus 11 of each in-vehicle device 10 according to the exemplary embodiment makes it possible to increase the likelihood of determining, as the transmission-target data, one of the sequential static data items with a high level of reliability as compared with a comparison example that determines, as the transmission-target data, one of the sequential static data items using any one of the estimation-method reliability and the housing-recognition reliability.

The first determination condition related to the sequential static data items corresponding to a recognized feature is configured such that the total reliability of one of the sequential static data items satisfies the predetermined third determination condition; the sequential static data items are acquired from the time when the recognized feature appears within the predetermined detectable region of a selected sensor in the sensors 60 until it is out of the predetermined detectable region of the selected sensor.

This therefore increases the likelihood of determining, as the transmission-target data, one of the sequential static data items for a recognized feature with a high level of reliability; the sequential static data items are acquired from the time when the recognized feature appears within the predetermined detectable region of the selected sensor until it is out of the predetermined detectable region of the selected sensor.

The third determination condition includes the second requirement that the total reliability of the one of the selected static data items is the highest among all the selected static data items within the predetermined range in the sequential static data items; the selected static data items within the predetermined range are acquired from the time when the recognized feature appears within the predetermined detectable region of the selected sensor, until it is out of the predetermined detectable region of the selected sensor, making it possible to further increase the likelihood of determining, as the transmission-target data, one of the sequential static data items for the recognized feature with a high level of reliability.

The second determination condition includes the fourth determination condition that shows a condition as to whether the consecutive data items, which include the selected dynamic data item and preceding dynamic data items, are stable for the predetermined period, making it possible to increase the likelihood of determining, as the transmission-target data, one of the sequential dynamic data items for the recognized feature with a high level of reliability.

The fourth determination condition includes the fifth requirement that the number of consecutive data items, including the selected one of the sequential dynamic data items and preceding dynamic data items that indicate the same operating information, is greater than or equal to the predetermined threshold. This therefore makes it possible to increase the likelihood of determining, as the transmission-target data, one of the sequential dynamic data items for the recognized feature, which is likely to be stable for a predetermined period.

The fourth determination condition includes the third requirement that the distance estimation method used for the distance estimation of the determination target feature corresponding to the selected one of the sequential dynamic data items is the predetermined distance estimation method. Previously selecting, as the predetermined distance estimation method, one of the first to fifth distance estimation methods, which is a method that is recognized as having higher reliability than the other distance estimation methods, depending on the type of a target feature makes it possible to further increase the likelihood of determining, as the transmission-target data, one of the sequential dynamic data items for the recognized feature with a high level of reliability. In particular, previously selecting, as the predetermined distance estimation method, the first distance estimation method enables the likelihood of determining, as the transmission-target data, one of the sequential dynamic data items for the recognized feature with a high level of reliability to be higher as compared with a case of selecting, as the predetermined distance estimation method, another distance estimation method.

The fourth determination condition includes the fourth requirement that the level of the housing-recognition reliability corresponding to the selected one of the sequential dynamic data items is higher than or equal to the predetermined housing-recognition reliability threshold. This therefore makes it possible to further increase the likelihood of determining, as the transmission-target data, one of the sequential dynamic data items for the recognized feature with a high level of reliability.

### MODIFICATIONS

The total reliability of any static data item according to the exemplary embodiment is identified based on the product of (i) the level of the estimation-method reliability and (ii) the level of the housing-recognition reliability of the static data item, but the present disclosure is not limited thereto. Specifically, the total reliability of any static data item according to the exemplary embodiment can be identified based on any method, such as the sum of the level of the estimation-method reliability and (ii) the level of the housing-recognition reliability of the static data item, that can obtain the greater the value of the total reliability of the static data item when the higher the level of the estimation-method reliability of the static data item and/or the housing-recognition reliability of the level of the static data item.

The first determination condition according to the exemplary embodiment is based on both the estimation-method reliability and the housing-recognition reliability, but can be based on any one of the estimation-method reliability and the housing-recognition reliability.

The first determination condition according to the present disclosure can be modified to include a requirement that the distance estimation method used for the distance estimation of the determination target feature corresponding to the selected one of the sequential static data items is one of the first distance estimation method having the level 9 of the estimation-method reliability and the second distance estimation method having the level 8 of the estimation-method reliability.

This modification makes it possible to increase the likelihood of determining, as the transmission-target data, one of the sequential static data items with a high level of reliability as compared with a comparison example that uses, as the distance estimation method, one of the other third to fifth distance estimation methods.

The third determination condition includes
(I) The first requirement that the total reliability of one of the selected static data items is higher than or equal to the predetermined threshold, and
(II) The second requirement that the total reliability of the one of the selected static data items is the highest among all the selected static data items within the predetermined range in the sequential static data items; the selected static data items within the predetermined range are acquired from the time when the recognized feature appears within the predetermined detectable region of the selected sensor, until it is out of the predetermined detectable region of one of the sensors 60.

The present disclosure is, however, not limited thereto.

Specifically, the third determination condition may include one of the first requirement and the second requirement, the other of which is omitted.

Additionally, the third determination condition may include, in place of the second requirement, a requirement that the total reliability of the one of the sequential static data items for a recognized feature includes the highest housing-recognition reliability in all the sequential static data items, which are acquired from the time when the recognized feature appears within the predetermined detectable region of the selected sensor, until it is out of the predetermined detectable region of one of the sensors 60.

Alternatively, the third determination condition may include, in place of the second requirement, a requirement that the one of the sequential static data items for a recognized feature that have the highest levels of the total reliability; the one of the sequential static data items is the closest to the timing at which the recognized feature exits the detectable region of the selected sensor.

The recognition unit 22 according to the exemplary embodiment uses one of the first to fifth distance estimation methods, but a part of the first to fifth distance estimation methods may be omitted. At least one of other distance estimation methods may be replaced with at least one of the first to fifth distance estimation methods.

Each static data item for a traffic light according to the exemplary embodiment includes dimensional data of the traffic light, but the present disclosure is not limited thereto. Specifically, each static data item for a traffic light according to the present disclosure may include at least one of (i) the position of the traffic light, (ii) the dimensions of the traffic light, (iii) the orientation of the traffic light, (iv) the distance of the traffic light from the corresponding vehicle, and (v) the type of the traffic light. This modification enables transmission of static data items for a traffic light with a high level of reliability; each of the static data items includes at least one of (i) the position of the traffic light, (ii) the dimensions of the traffic light, (iii) the orientation of the traffic light, (iv) the distance of the traffic light from the corresponding vehicle, and (v) the type of the traffic light.

The transmission data generating apparatuses 11 and their transmission data generating methods disclosed in the present disclosure can be implemented by a dedicated computer including a memory and a processor programmed to perform one or more functions embodied by one or more computer programs.

The transmission data generating apparatuses 11 and their transmission data generating methods disclosed in the present disclosure disclosed in the present disclosure can also be implemented by a dedicated computer including a processor comprised of one or more dedicated hardware logic circuits.

The transmission data generating apparatuses 11 and their transmission data generating methods disclosed in the present disclosure can further be implemented by a processor system comprised of a memory, a processor programmed to perform one or more functions embodied by one or more computer programs, and one or more hardware logic circuits.

The one or more programs can be stored in a computer-readable non-transitory storage medium as instructions to be carried out by a computer or a processor.

The present disclosure can be implemented in various forms. For example, the present disclosure may be embodied as object detection methods, object detection apparatuses, computer program instructions for implementing each object detection method, and/or non-transitory storage media, each of which stores the computer program instructions.

The present disclosure is not limited to the above exemplary embodiment and its modifications, and can be implemented by various configurations within the scope of the present disclosure. For example, technical features included in the exemplary embodiment and its modifications, which correspond to technical features included in the exemplary aspect described in the SUMMARY of the present disclosure, can be freely combined with each other or can be freely replaced with another feature in order to solve a part or all of the above issue and/or achieve a part or all of the above advantageous benefits. One or more of the technical features included in the above exemplary embodiment and its modifications, which are not described as essential elements in the specification, can be omitted as necessity arises.

The present disclosure can be implemented as methods of controlling a collision mitigation function, computer program instructions for implementing each of the methods, and/or non-transitory storage media, each of which stores the computer program instructions.

The present disclosure can be grasped as the following technological aspects:

### [First Technological Aspect]

A transmission data generation apparatus (11) for a vehicle according to the first technological aspect includes a data recognition unit (22) configured to recognize, based on measurements from at least one sensor (60) mounted to the vehicle, a target feature, and generate, based on the target feature, sequential feature data items, each of which represents the target feature. Each of the sequential feature data items includes at least one of a dynamic data item that is changeable over time and a static data item that does not change over time.

The transmission data generation apparatus includes a transmission-target data determiner (24) configured to determine, when each of the sequential feature data items includes the static data item so that sequential static data items as the sequential feature data items are defined, whether a first determination condition for identifying one of the sequential static data items as one or more transmission targets is satisfied. The transmission-target data determiner (24) is configured to determine, when each of the sequential feature data items includes the dynamic data item so that sequential dynamic data items as the sequential feature data items are defined, whether a second determination condition for identifying one of the sequential dynamic data items as the one or more transmission targets is satisfied, the first determination condition and the second determination condition being independent from each other.

The transmission data generation apparatus includes a transmission data generator (25) configured to perform at least one of (i) a first task of generating, in response to determination that the first determination condition is satisfied, transmission-target data based on the one of the sequential static data items, and (ii) a second task of generating, in response to determination that the second determination condition is satisfied, the transmission-target data based on the one of the sequential dynamic data items.

### [Second Technological Aspect]

In the transmission data generation apparatus according to the second technological aspect, which depends from the first technological aspect, the recognition unit is configured to estimate, for each feature data, a distance of the target feature from the vehicle using one of plural distance estimation methods, each of which has a corresponding level of estimation-method reliability. The recognition unit is configured to acquire, for each feature data item, a level of the estimation-method reliability corresponding to one of the plural distance estimation methods used to estimate the distance of the target feature corresponding to the feature data item from the vehicle, and acquire, for each feature data item, a level of housing-recognition reliability for the target feature. The first determination condition is based on the estimation-method reliability and the housing-recognition reliability.

### [Third Technological Aspect]

In the transmission data generation apparatus according to the third technological aspect, which depends from the second technological aspect, the one of the sequential static data items is one of selected static data items within a predetermined range in the sequential static data items. The selected static data items is recognized by the recognition unit from a time when the target feature appears within a predetermined detectable region of the at least one sensor until the target feature is out of the predetermined detectable region of the at least one sensor. The first determination condition is configured such that a total reliability of the one of the selected static data items satisfies a predetermined third determination condition. The total reliability of the one of the selected static data items is identified based on (i) the level of the estimation-method reliability corresponding to the one of the selected static data items and (ii) the level of the housing-recognition reliability corresponding to the one of the selected static data items.

### [Fourth Technological Aspect]

In the transmission data generation apparatus according to the fourth technological aspect, which depends from the second technological aspect, the third determination condition includes a requirement that the total reliability of the one of the selected static data items is the highest in all the selected static data items.

### [Fifth Technological Aspect]

In the transmission data generation apparatus according to the fifth technological aspect, which depends from any one of the second to fourth technological aspects, the plural distance estimation methods include a first distance estimation method that acquires a three-dimensional point cloud of a plurality of points constituting the target feature, and a second distance estimation method that compares a measured apparent one of lateral and vertical widths of the target feature with an actual one of lateral and vertical widths of the target feature. The first determination condition includes a condition that the level of the estimation-method reliability corresponding to the one of the sequential static data items is one of a first level corresponding to the first distance estimation method and a second level corresponding to the second distance estimation method.

### [Sixth Technological Aspect]

In the transmission data generation apparatus according to the sixth technological aspect, which depends from any one of the first to fifth technological aspects, the second determination condition for identifying the one of the sequential dynamic data items includes a fourth determination condition that shows a condition as to whether consecutive data items, which include the one of the dynamic data items and preceding dynamic data items, are stable for a predetermined period.

### [Seventh Technological Aspect]

In the transmission data generation apparatus according to the seventh technological aspect, which depends from the sixth technological aspect, the fourth determination condition includes a requirement that (i) the consecutive data items indicate same operating information, and (ii) the number of the consecutive data items is greater than or equal to a predetermined threshold.

### [Eighth Technological Aspect]

In the transmission data generation apparatus according to the eighth technological aspect, which depends from the sixth or seventh technological aspect, the recognition unit is configured to estimate, for each feature data, a distance of the target feature from the vehicle using one of plural distance estimation methods, the plural distance estimation methods including a point-cloud distance estimation method that acquires a three-dimensional point cloud of a plurality of points constituting the target feature. The fourth determination condition includes a requirement that one of the distance estimation methods used for estimation of the distance of the determination target feature corresponding to the one of the sequential dynamic data items is the point-cloud distance estimation method.

### [Ninth Technological Aspect]

In the transmission data generation apparatus according to the ninth technological aspect, which depends from any one of the sixth to eighth technological aspects, the recognition unit is configured to acquire, for each feature data item, a level of housing-recognition reliability for the target feature. The fourth determination condition includes a requirement that the level of the housing-recognition reliability corresponding to the one of the sequential dynamic data items is higher than or equal to a predetermined housing-recognition reliability threshold.

### [Tenth Technological Aspect]

In the transmission data generation apparatus according to the tenth technological aspect, which depends from any one of the first to ninth technological aspects, the target feature is a traffic light, and each of the static data items includes at least one of a position of the traffic light, dimensions of the traffic light, an orientation of the traffic light, and a type of the traffic light. Each of the dynamic data items includes illumination information on the traffic light.

### [Eleventh Technological Aspect]

A transmission data generation method for a vehicle according to the eleventh technological aspect includes recognizing, based on measurements from at least one sensor mounted to the vehicle, a target feature; and generating, based on the target feature, sequential feature data items, each of which represents the target feature, each of the sequential feature data items including at least one of a dynamic data item that is changeable over time and a static data item that does not change over time.

The transmission data generation method includes determining, when each of the sequential feature data items includes the static data item so that sequential static data items as the sequential feature data items are defined, whether a first determination condition for identifying one of the sequential static data items as one or more transmission targets is satisfied. The transmission data generation method includes determining, when each of the sequential feature data items includes the dynamic data item so that sequential dynamic data items as the sequential feature data items are defined, whether a second determination condition for identifying one of the sequential dynamic data items as the one or more transmission targets is satisfied, the first determination condition and the second determination condition being independent from each other.

The transmission data generation method includes performing at least one of
(I) A first task of generating, in response to determination that the first determination condition is satisfied, transmission-target data based on the one of the sequential static data items, and
(II) A second task of generating, in response to determination that the second determination condition is satisfied, the transmission-target data based on the one of the sequential dynamic data items

### [Twelfth Technological Aspect]

A program product of transmission-data generation for a vehicle according to the twelfth technological aspect includes a non-transitory storage medium, and program instructions stored in the non-transitory storage medium.

The program instructions cause a processor to
(I) Recognize, based on measurements from at least one sensor mounted to the vehicle, a target feature,
(II) Generate, based on the target feature, sequential feature data items, each of which represents the target feature, each of the sequential feature data items including at least one of a dynamic data item that is changeable over time and a static data item that does not change over time,
(III) Determine, when each of the sequential feature data items includes the static data item so that sequential static data items as the sequential feature data items are defined, whether a first determination condition for identifying one of the sequential static data items as one or more transmission targets is satisfied,
(IV) Determine, when each of the sequential feature data items includes the dynamic data item so that sequential dynamic data items as the sequential feature data items are defined, whether a second determination condition for identifying one of the sequential dynamic data items as the one or more transmission targets is satisfied, the first determination condition and the second determination condition being independent from each other, and
(V) Perform at least one of (i) a first task of generating, in response to determination that the first determination condition is satisfied, transmission-target data based on the one of the sequential static data items, and (ii) a second task of generating, in response to determination that the second determination condition is satisfied, the transmission-target data based on the one of the sequential dynamic data items

1. A transmission data generation apparatus for a vehicle, the transmission data generation apparatus comprising:
a data recognition unit configured to:
recognize, based on measurements from at least one sensor mounted to the vehicle, a target feature; and
generate, based on the target feature, sequential feature data items, each of which represents the target feature, each of the sequential feature data items including at least one of a dynamic data item that is changeable over time and a static data item that does not change over time;
a transmission-target data determiner configured to:
determine, when each of the sequential feature data items includes the static data item so that sequential static data items as the sequential feature data items are defined, whether a first determination condition for identifying one of the sequential static data items as one or more transmission targets is satisfied; and
determine, when each of the sequential feature data items includes the dynamic data item so that sequential dynamic data items as the sequential feature data items are defined, whether a second determination condition for identifying one of the sequential dynamic data items as the one or more transmission targets is satisfied, the first determination condition and the second determination condition being independent from each other; and
a transmission data generator configured to perform at least one of:
a first task of generating, in response to determination that the first determination condition is satisfied, transmission-target data based on the one of the sequential static data items; and
a second task of generating, in response to determination that the second determination condition is satisfied, the transmission-target data based on the one of the sequential dynamic data items.

2. The transmission data generation apparatus according to claim 1, wherein:
the recognition unit is configured to:
estimate, for each feature data, a distance of the target feature from the vehicle using one of plural distance estimation methods, each of which has a corresponding level of estimation-method reliability;
acquire, for each feature data item, a level of the estimation-method reliability corresponding to one of the plural distance estimation methods used to estimate the distance of the target feature corresponding to the feature data item from the vehicle;
acquire, for each feature data item, a level of housing-recognition reliability for the target feature; and
the first determination condition is based on the estimation-method reliability and the housing-recognition reliability.

3. The transmission data generation apparatus according to claim 2, wherein:
the one of the sequential static data items is one of selected static data items within a predetermined range in the sequential static data items,
the selected static data items being recognized by the recognition unit from a time when the target feature appears within a predetermined detectable region of the at least one sensor until the target feature is out of the predetermined detectable region of the at least one sensor;
the first determination condition is configured such that a total reliability of the one of the selected static data items satisfies a predetermined third determination condition; and
the total reliability of the one of the selected static data items is identified based on (i) the level of the estimation-method reliability corresponding to the one of the selected static data items and (ii) the level of the housing-recognition reliability corresponding to the one of the selected static data items.

4. The transmission data generation apparatus according to claim 3, wherein:
the third determination condition includes a requirement that the total reliability of the one of the selected static data items is the highest in all the selected static data items.

5. The transmission data generation apparatus according to claim 2, wherein:
the plural distance estimation methods include:
a first distance estimation method that acquires a three-dimensional point cloud of a plurality of points constituting the target feature; and
a second distance estimation method that compares a measured apparent one of lateral and vertical widths of the target feature with an actual one of lateral and vertical widths of the target feature; and
the first determination condition includes a condition that the level of the estimation-method reliability corresponding to the one of the sequential static data items is one of a first level corresponding to the first distance estimation method and a second level corresponding to the second distance estimation method.

6. The transmission data generation apparatus according to claim 1, wherein:
the second determination condition for identifying the one of the sequential dynamic data items includes a fourth determination condition that shows a condition as to whether consecutive data items, which include the one of the dynamic data items and preceding dynamic data items, are stable for a predetermined period.

7. The transmission data generation apparatus according to claim 6, wherein:
the fourth determination condition includes a requirement that (i) the consecutive data items indicate same operating information, and (ii) the number of the consecutive data items is greater than or equal to a predetermined threshold.

8. The transmission data generation apparatus according to claim 6, wherein:
the recognition unit is configured to estimate, for each feature data, a distance of the target feature from the vehicle using one of plural distance estimation methods, the plural distance estimation methods including a point-cloud distance estimation method that acquires a three-dimensional point cloud of a plurality of points constituting the target feature; and
the fourth determination condition includes a requirement that one of the distance estimation methods used for estimation of the distance of the determination target feature corresponding to the one of the sequential dynamic data items is the point-cloud distance estimation method.

9. The transmission data generation apparatus according to claim 6, wherein:
the recognition unit is configured to acquire, for each feature data item, a level of housing-recognition reliability for the target feature; and
the fourth determination condition includes a requirement that the level of the housing-recognition reliability corresponding to the one of the sequential dynamic data items is higher than or equal to a predetermined housing-recognition reliability threshold.

10. The transmission data generation apparatus according to claim 1, wherein:
the target feature is a traffic light;
each of the static data items includes at least one of a position of the traffic light, dimensions of the traffic light, an orientation of the traffic light, and a type of the traffic light; and
each of the dynamic data items includes illumination information on the traffic light.

11. A transmission data generation method for a vehicle, the transmission data generation method comprising:
recognizing, based on measurements from at least one sensor mounted to the vehicle, a target feature;
generating, based on the target feature, sequential feature data items, each of which represents the target feature, each of the sequential feature data items including at least one of a dynamic data item that is changeable over time and a static data item that does not change over time;
determining, when each of the sequential feature data items includes the static data item so that sequential static data items as the sequential feature data items are defined, whether a first determination condition for identifying one of the sequential static data items as one or more transmission targets is satisfied;
determining, when each of the sequential feature data items includes the dynamic data item so that sequential dynamic data items as the sequential feature data items are defined, whether a second determination condition for identifying one of the sequential dynamic data items as the one or more transmission targets is satisfied, the first determination condition and the second determination condition being independent from each other; and
performing at least one of:
a first task of generating, in response to determination that the first determination condition is satisfied, transmission-target data based on the one of the sequential static data items; and
a second task of generating, in response to determination that the second determination condition is satisfied, the transmission-target data based on the one of the sequential dynamic data items.

12. A program product of transmission-data generation for a vehicle, the program product comprising:
a non-transitory storage medium; and
program instructions stored in the non-transitory storage medium,
the program instructions causing a processor to:
recognize, based on measurements from at least one sensor mounted to the vehicle, a target feature;
generate, based on the target feature, sequential feature data items, each of which represents the target feature, each of the sequential feature data items including at least one of a dynamic data item that is changeable over time and a static data item that does not change over time;
determine, when each of the sequential feature data items includes the static data item so that sequential static data items as the sequential feature data items are defined, whether a first determination condition for identifying one of the sequential static data items as one or more transmission targets is satisfied;
determine, when each of the sequential feature data items includes the dynamic data item so that sequential dynamic data items as the sequential feature data items are defined, whether a second determination condition for identifying one of the sequential dynamic data items as the one or more transmission targets is satisfied, the first determination condition and the second determination condition being independent from each other; and
perform at least one of:
a first task of generating, in response to determination that the first determination condition is satisfied, transmission-target data based on the one of the sequential static data items; and
a second task of generating, in response to determination that the second determination condition is satisfied, the transmission-target data based on the one of the sequential dynamic data items.
